(19) United States
(12) Patent Application Publication
(10) Pub. No.: US 2006/0126346 A1
(43) Pub. Date: Jun. 15, 2006

(54) Apparatus for providing light

(75) Inventor: Paul R. Mighetto, Berkeley, CA (US)

Correspondence Address: BEYER WEAVER & THOMAS LLP, P.O. BOX 70250, OAKLAND, CA, 94612-0250, US

(73) Assignee: Paul R. Mighetto

(21) Appl. No.: 11/009,576

(22) Filed: Dec. 10, 2004

(51) Int. Cl. F21V 29/00

(52) U.S. Cl. 362/373

(57) ABSTRACT

Apparatus for providing light and methods for fabricating them are described. Lighting devices based on light emitting diodes (LEDs) coupled to a frame allow for efficient dissipation of heat generated by the LEDs. Each lighting device can be configured to be easily expandable, replaceable, and adaptable to different lighting device systems. The use of reclaimed materials in the present invention is also described, which may further add value to the apparatus and methods of the present invention.

### BACKGROUND OF THE INVENTION

1. Field of the Invention

The present invention relates to lighting. More specifically, the present invention relates to apparatus for providing light and methods for fabricating them.

2. Description of the Prior Art

Conventional lighting devices encompass many types. One type is the incandescent light bulb, which is low cost but very inefficient. It generates between 16 lumens per watt for a tungsten bulb to 22 lumens per watt for a halogen bulb. A second type is the fluorescent tube, which is more efficient. It generates between 50-100 lumens per watt, allowing large energy savings. However, the fluorescent tube is bulky and fragile. Furthermore, it requires a starter circuit.

A third type is the light emitting diode (LED). LEDs are generally robust and moderately efficient with up to 32 lumens per watt. As LED technology advances, brighter and more efficient LEDs are being developed. Although LEDs are good sources of light, they can generate a considerable amount of heat. The heat can be damaging to the performance of the LEDs (e.g., shorter lifespan).

Therefore, it would be desirable to provide improved techniques and mechanisms for providing light based on LEDs while controlling the heat generated from the LEDs.

### SUMMARY OF THE INVENTION

Apparatus for providing light and methods for fabricating them are provided in the present invention. The use of reclaimed materials in the present invention is also provided, which may add further value to the apparatus and methods of the present invention.

In one aspect of the present invention, a lighting device with multiple lighting elements (e.g., light emitting diodes) is provided. The lighting device includes a frame configured for receiving the multiple lighting elements and for controlling the heat generated from the multiple lighting elements. Further, the lighting device includes electrical circuitry for providing electricity to the multiple lighting elements.

In one embodiment of the present invention, the lighting device includes a chassis for receiving the frame. The chassis and frame can be coupled together, such as with an appropriately sized washer. Typically, the chassis includes electrical contacts that form a portion of the electrical circuitry. The electrical contacts can facilitate receiving electricity from a power supply and delivering electricity to the multiple lighting elements. The electrical contacts can be screw type contacts. In another embodiment of the present invention, the lighting device includes an electrical power converter, whereby the electrical power converter provides suitable electricity to the multiple lighting elements. In some cases, the electrical power converter can be housed within the frame.

In another aspect of the present invention, a lighting device system is provided with a lighting device. The lighting device system includes a socket, which is configured to electrically connect a power supply to the electrical circuitry of the lighting device. The lighting device system may include a switch for controlling the delivery of electricity from the power supply to the electrical circuitry of the lighting device.

In yet another aspect of the present invention, a method of fabricating the lighting device is provided. The method includes providing a frame for receiving multiple lighting elements and for conducting heat from them. The method also includes attaching the multiple lighting elements onto the frame and electrically connecting the multiple lighting elements to multiple electrical contacts.

These and other features and advantages of the present invention will be presented in more detail in the following specification of the invention and the accompanying figures, which illustrate by way of example the principles of the invention.

### BRIEF DESCRIPTION OF THE DRAWINGS

The invention may best be understood by reference to the following description taken in conjunction with the accompanying drawings, which illustrate specific embodiments of the present invention.

FIG. 1 is a diagrammatic representation of a lighting device according to various embodiments of the present invention.

FIG. 2 is a diagrammatic representation of a lighting device according to various embodiments of the present invention.

FIG. 3 is a diagrammatic representation of a lighting device system according to various embodiments of the present invention.

FIG. 4 is a diagrammatic representation of a lighting device system according to various embodiments of the present invention.

FIG. 5 is a schematic diagram of a lighting device according to various embodiments of the present invention.

FIG. 6 is a schematic diagram of a lighting device according to various embodiments of the present invention.

FIG. 7A is a top perspective view of a lighting element mount system having a mount for use with a lighting element according to various embodiments of the present invention.

FIG. 7B is a bottom perspective view of a lighting element mount system having a mount for use with a lighting element according to various embodiments of the present invention.

FIG. 8 is a flow chart for forming a lighting device according to various embodiments of the present invention.

FIG. 9 illustrates a graph plotting temperature versus time for one embodiment of the present invention.

FIG. 10 illustrates a graph plotting temperature versus time for another embodiment of the present invention.

FIG. 11 illustrates a graph plotting temperature versus time for yet another embodiment of the present invention.

### DETAILED DESCRIPTION OF SPECIFIC EMBODIMENTS

Reference will now be made in detail to some specific embodiments of the invention including the best modes contemplated by the inventor for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

Apparatus for providing light and methods for fabricating them are described. Lighting devices based on light emitting diodes (LEDs) coupled to a frame allow for efficient dissipation of heat generated by the LEDs. Each lighting device can be configured to be easily expandable, replaceable, and adaptable to different lighting device systems. The use of reclaimed materials in the present invention is also described, which may further add value to the apparatus and methods of the present invention.

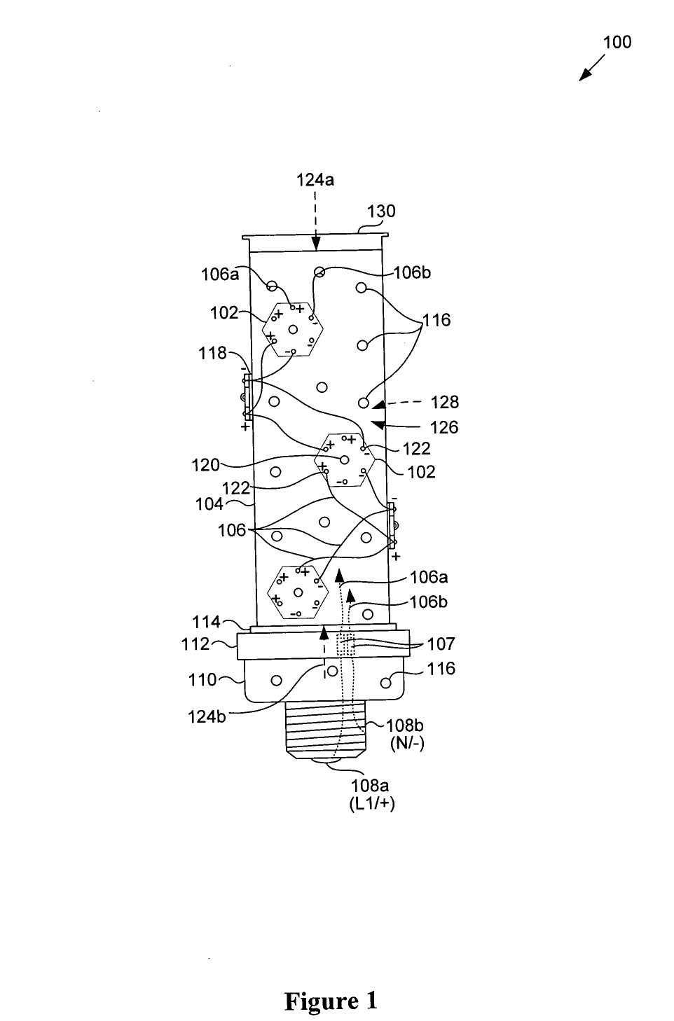

To begin, FIG. 1 is a diagrammatic representation of a lighting device 100 according to a first embodiment of the present invention. Lighting device 100 is based on using multiple lighting elements. For example, lighting elements may include LEDs 102. LEDs 102 may either operate on alternating current (AC) or direct current (DC). For example, LEDs 102 may operate on 120 Volt AC or between 7.8 to 24.6 Volts DC. LEDs may have any power rating (measured in Watts). Typically, the brightness (measured in Lumens) of a LED correlates with the LED's power rating. Therefore, a 5-Watt LED will be generally brighter than a 3-Watt LED, which in turn is generally brighter than a 1-Watt LED.

Many LEDs 102 provide light in a substantially directional manner. Further, LEDs 102 are often configured for longer life spans than other conventional lighting mechanisms (e.g., incandescent light bulb). LEDs 102 can have a life span between 1000-100,000 hours. Since LEDs 102 may last at least ten times longer than a conventional light source, the cost of replacing the light source can be significantly reduced. As indicated earlier, LEDs 102 are more energy efficient than incandescent light sources while approaching the efficiency of fluorescents. Unlike most fluorescent light sources, LEDs 102 generally contain no mercury and have cold start capabilities (e.g., having no ignition problems in cold environments such as down to −40° C.).

Each one of the LEDs 102 may include a LED lens 120 and multiple connection points 122 for forming electrical connections. Connection points 122 may be used to connect a LED to various components (e.g., with another LED) of lighting device 100 via electrical circuitry (e.g., interconnects 106, such as copper wiring). LED lens 120 may be chosen based on the degree of light diffusion, protection of the LED, and/or coloration sought for the application. Connection points 122 are interconnected such that electricity can be delivered to power the LED. For example, connection points 122 may be divided into polarities (e.g., “+” and “−”) for DC voltage and voltage potentials (e.g., (“L1”: line) and (“N”: neutral)) for AC voltage. Additionally, the connection points 122 may be interconnected together based on their common polarities or voltage potentials.

As shown in FIG. 1, LEDs 102 are coupled to a frame 104. Frame 104 is configured to support LEDs 102 and further configured to conduct heat away from them. Accordingly, frame 104 should be made from a heat conducting material, such as metal. In some cases, frame 104 is configured to conduct heat from LEDs 102 such that a maximum temperature of lighting device 100 does not exceed 250° F. Generally, frame 104 can be further configured to receive LEDs 102 such that at least two of the LEDs 102 are facing in different directions away from frame 104.

Frame 104 can be any size or shape. For example, frame 104 may be flat, honeycomb shaped, square shaped, triangle shaped, polygon shaped, etc. For instance, frame 104 can be a pipe having a gauge thickness suitable for the application. The pipe may have two opposite end openings 124a and 124b with a cylindrical cross-section. A cap 130 may be configured to cover the end openings (e.g., 124a). Cap 130 can be made from any suitable material, such as plastic or even metal. LEDs 102 can also be mounted onto cap 130. Preferably, the pipe has an outer surface 126 configured to receive LEDs 102 and maximize heat transfer between LEDs 102 and the pipe. In some cases, the pipe may have outer surfaces 126 (e.g., flat) that match the attaching surfaces (e.g., flat) of LEDs 102. Furthermore, outer surfaces 126 around LEDs 102 can be shaped or coated to reflect the light from LEDs 102. In sum, the frame's material, thickness, and its shape should be selected to provide adequate support as well as thermal dissipation capabilities to the LEDs.

In order to increase the thermal dissipation capabilities provided by frame 104, ventilation holes 116 may be included in frame 104. Ventilation holes 116 penetrate frame 104 from outer surface 126 to inner surface 128. Ventilation holes 116 may be of any size and number in quantity. In some cases, ventilation holes 116 are large enough to thread interconnects 106 through them. As such, portions of interconnects 106 may be hidden from view by weaving through ventilation holes 116. Therefore, ventilation holes 116 may provide further heat dissipation capabilities as well as support structures for interconnects 106.

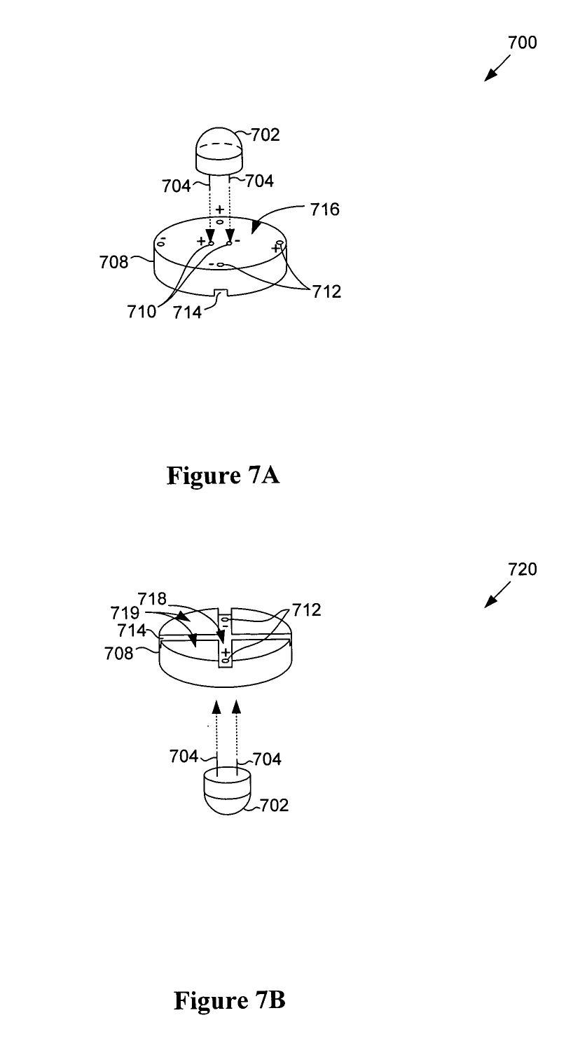

Any mechanism or technique may be used to couple LEDs 102 to frame 104. For example, as discussed below in reference to FIGS. 7A and 7B, a lighting element mounting system may be used. For another example, a thermal interface material 118 may be used for attaching LEDs 102 to frame 104. Thermal interface material 118 can allow heat from the LEDs to transfer to the frame. Thermal interface material 118 may include, but is not limited to, solder, epoxy, and double sided heat sink adhesive tape. Solder may have a melting temperature in the range of 450° F. to 600° F. Solder may be composed of 4% silver and 96% tin (no lead). It should be noted that thermal interface material is optional (e.g., where the LED can dissipate heat to the frame directly).

In general, thermal interface material 118 should process adequate adhesive properties to support LEDs 102 to frame 104. Preferably, thermal interface material 118 should also process superior heat conducting properties. That is, the amount of heat transfer between LEDs 102 and frame 104 should be maximized by thermal interface material 118. Generally, the selected thermal interface material 118 (as well as the selected material for frame 104) can depend on maximizing the amount of heat dissipation from the LEDs in order for the LEDs to operate normally and maximize their lifespan. Additionally, thermal interface material 118 should be able to withstand the heat conducted from the LEDs without substantially losing its coupling and thermal effects.

Lighting device 100 may also include a chassis 110 configured to receive frame 104. Chassis 110 may resemble a conventional base of an incandescent light bulb. Chassis 110 may include a plurality of electrical contacts 108a and 108b for connecting a power supply to the electrical circuitry of lighting device 100. The electrical contacts may be screw type contacts. That is, screw type contacts require mechanical coupling (e.g., screwing) to form the electrical connections. Typically, chassis 110 contains a cavity that may be used to route interconnects 106 to/from electrical contacts 108a and 108b. For instance, one interconnect may be used to connect to electrical contact 108a (e.g., used for L1 or “+” polarity) and another interconnect used to connect to electrical contact 108b (e.g., used for N or “−” polarity). Similar to frame 104, ventilation holes 116 may also be integrated into chassis 110.

In order to secure frame 104 to chassis 110, any suitable mechanism or technique may be used. For example, an inner washer 114 may be used. Inner washer 114 is configured to hold in place a portion of frame 104 within chassis 110. Likewise, in order to secure chassis 110 to inner washer 114, an outer washer 112 may be used. Outer washer 112 is configured to hold in place a portion of chassis 110 with inner washer 114. Inner washer 114 and outer washer 112 may be made from rubber or any other suitable material. Inner washer 114 and outer washer 112 can be of any shape suitable for the application. For example, a circular washer may be used for a pipe with a circular cross section. The selection of inner washer 114 and outer washer 112 may be based on how tight of a connection is sought between chassis 110 and frame 104. For example, inner washer 114 and outer washer 112 may be selected to facilitate a connection that may be easily separable for maintenance purposes, such as when accessing interconnects 106 within chassis 110/frame 104.

In general, lighting device 100 includes electrical circuitry for providing electricity to LEDs 102 and any other electrical component of lighting device 100. Electrical circuitry may include interconnects 106 and various connectors 107 (including circuit protection devices; splice kits; heat shrink tubes, etc.).

Interconnects 106 are generally used to electrically connect together various components of lighting device 100. For example, interconnects 106 may be used to connect LEDs 102 in any electrical circuit formation. In some cases, interconnects 106 are used to connect a portion of LEDs 102 in parallel. In other cases, interconnects 106 are used to connect a portion of LEDs 102 in series. Yet, in other cases, interconnects are used to connect LEDs 102 in both parallel and series formation (e.g., 2×4: (2) branches connected in parallel, where each branch has (4) LEDs connected in series, 2×5, 3×4, 3×5, etc). Referring to FIG. 1, interconnects 106a and 106b are shown interconnecting electrical contacts 108a and 108b to LEDs 102 where LEDs 102 are further connected in parallel with interconnects 106.

Connectors 107 may be inserted at any suitable portion of the electrical circuit of lighting device 100. In some cases, connectors 107 are inserted to allow easy separation of portions of lighting device 100. For example, as shown in FIG. 1, connectors 107 located approximately where frame 104 and chassis 110 are connected can facilitate both frame 104 and chassis 110 to be completely decoupled from each other. For another example, connectors 107 may be located between interconnected LEDs such that various LEDs may be easily separated from one another. Connectors 107 may also provide circuit protection capabilities, such as with a fuse or circuit breaker.

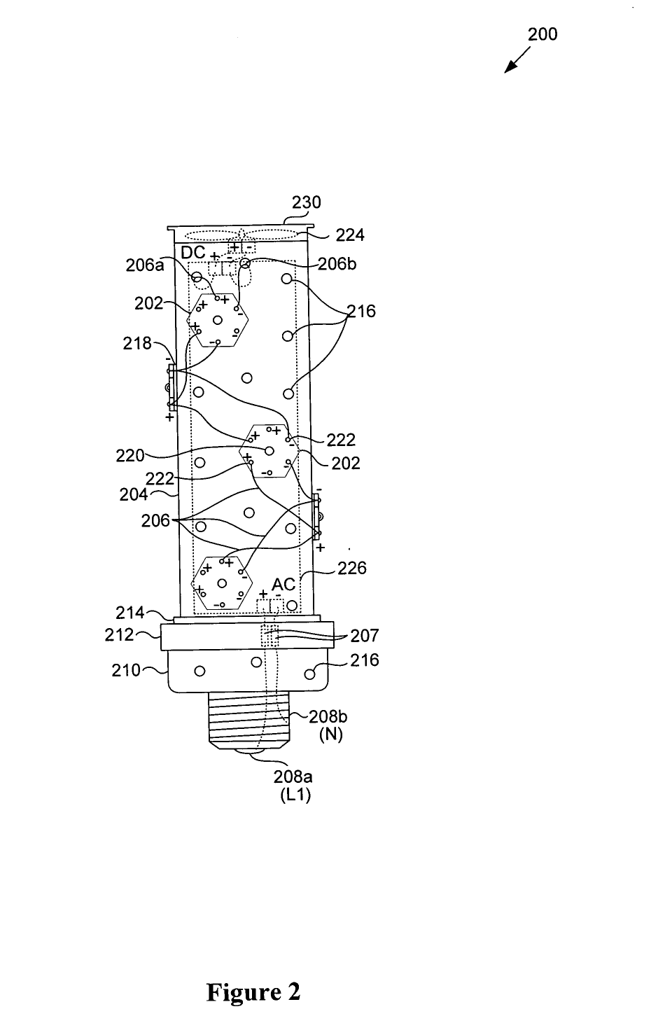

Next, FIG. 2 is a diagrammatic representation of a lighting device 200 according to a second embodiment of the present invention. Lighting device 200 is similar to lighting device 100. For instance, lighting device 200 includes multiple LEDs 202, a frame 204, interconnects 206 (including 206a and 206b), connectors 207, electrical contacts 208a and 208b, chassis 210, outer washer 212, inner washer 214, ventilation holes 216, thermal interface material 218, LED lens 220, connection points 222, and cap 230. However, lighting device 200 also includes an electrical power converter 226 and a fan 224 integrated into cap 230.

The purpose of electrical power converter 226 is to convert one electrical rating to another electrical rating. For example, electrical power converter 226 may be used to convert 120 Volts AC to 24 Volts DC. Any suitable electrical power converter may be used to supply electricity to LEDs 202 or other electrical component of lighting device 200. For example, Advance 10-Watt 350 mA Xitanium LED driver (model/part #LED120A0350C28FO), available from Advance of Rosemont, Ill. Generally, the electricity from power converter 226 at least matches the electrical ratings of the LEDs 202. As shown, electrical power converter 226 is configured to be disposed within frame 204. In the case where frame 204 is a pipe, electrical power converter 226 can slide into the pipe from the end openings (e.g., 124a and 124b).

Fan 224 is shown integrated into cap 230 and is optional. The use of fan 224 may depend on the configuration (e.g., number of LEDs) of the lighting device. Fan 224 is configured to increase the heat dissipation from LEDs 202, frame 204, and/or electrical power converter 226. In the case where frame 204 is a pipe, fan 224 is configured to draw air from inside the pipe to outside the pipe. Both fan 224 and electrical power converter 226 can be interconnected with LEDs 202 with electrical circuitry.

An advantage of lighting devices 100 and 200 is that they could be scalable lighting devices. That is, both lighting device 100 and lighting device 200 can each be configured to allow either a larger or smaller number of lighting elements based on the application. For example, the frame can be selected with a length and pre-wired (e.g., using the lighting element mounting system discussed in FIGS. 7A and 7B) accordingly to receive any suitable number of lighting elements. Therefore, when the application requires more light, more lighting elements can be easily added to the lighting device. Alternatively, when the application requires less light or when the lighting device is too hot, lighting elements can be easily removed from the lighting device. Furthermore, lighting devices 100 and 200 can be configured with dimmer controls.

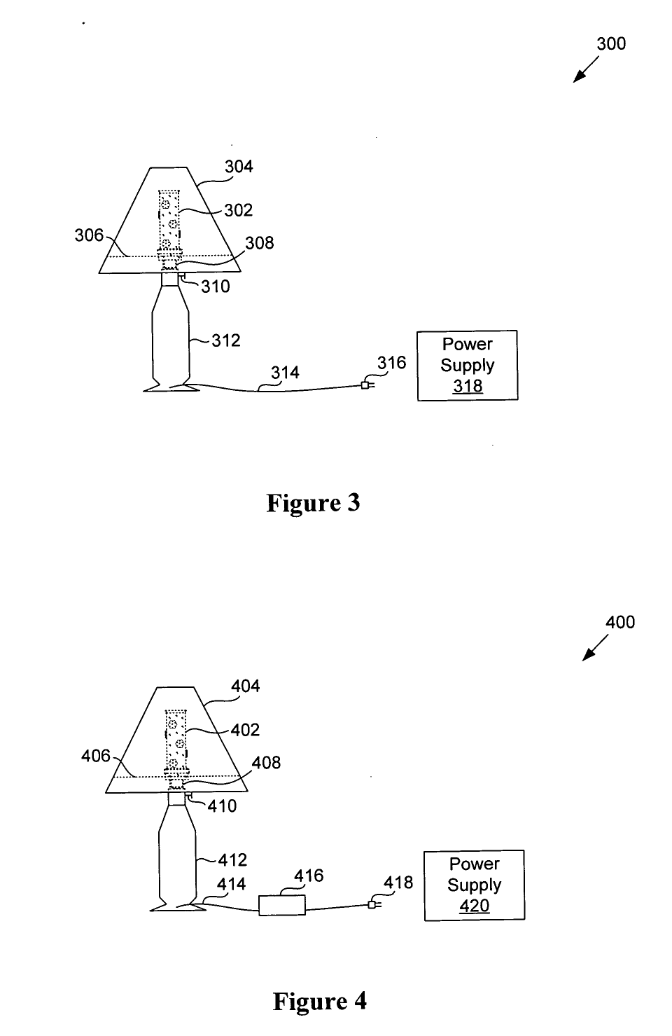

FIG. 3 is a diagrammatic representation of a lighting device system 300 according to a first embodiment of the present invention. Lighting device system 300 can resemble a conventional lamp. Lighting device system 300 includes a lighting device 302 (such as lighting devices 100 and 200) powered from a power supply 318. Power supply 318 may be based either on fuel cells, generators, wind power, hydropower, solar power, or thermal power. Power supply 318 is configured to supply electricity to lighting device 302 via an electrical circuit, which may be formed in part by an electrical plug 316, an electrical cord 314, a switch 310, and a socket 308. Generally, lighting device 302, socket 308, switch 310, electrical cord 314, electrical plug 316 and power supply 318 are electrically connected using any conventional mechanism or technique. Switch 310 is often included to control (i.e., via opening or closing the circuit) the electricity flowing between lighting device 302 and power supply 318.

A base 312 is also included in lighting device system 300 to elevate lighting device 302 to an appropriate height from the surface of which base 312 is mounted. Additionally, lighting device system 300 may include a cover 304 optionally supported by a brace 306. Cover 304 and/or brace 306 can be integrated with lighting device 302. In general, cover 304 can be positioned around lighting device 302 such that light from the lighting device 302 can be diffused. Since LEDs are substantially directional, cover 304 can be configured to control the direction of the light emitted from the LEDs. Cover 304 can be any suitable shape for the application. Cover 304 can also be made from any suitable material, such as plastic, glass, or paper. Therefore, cover 304 may be chosen based on the degree of light diffusion, protection of the LEDs, and/or coloration sought for the application. In some cases, cover 304 includes a slot to allow heat from the lighting device 302 to escape through.

FIG. 4 is a diagrammatic representation of a lighting device system 400 according to a second embodiment of the present invention. Lighting device system 400 is similar to lighting device 300. For example, lighting device system 400 also includes a lighting device 402, a cover 404, a brace 406, a socket 408, a switch 410, a base 412, an electrical cord 414, an electrical plug 418, and a power supply 420. However, lighting device system 400 includes an external electrical power converter 416.

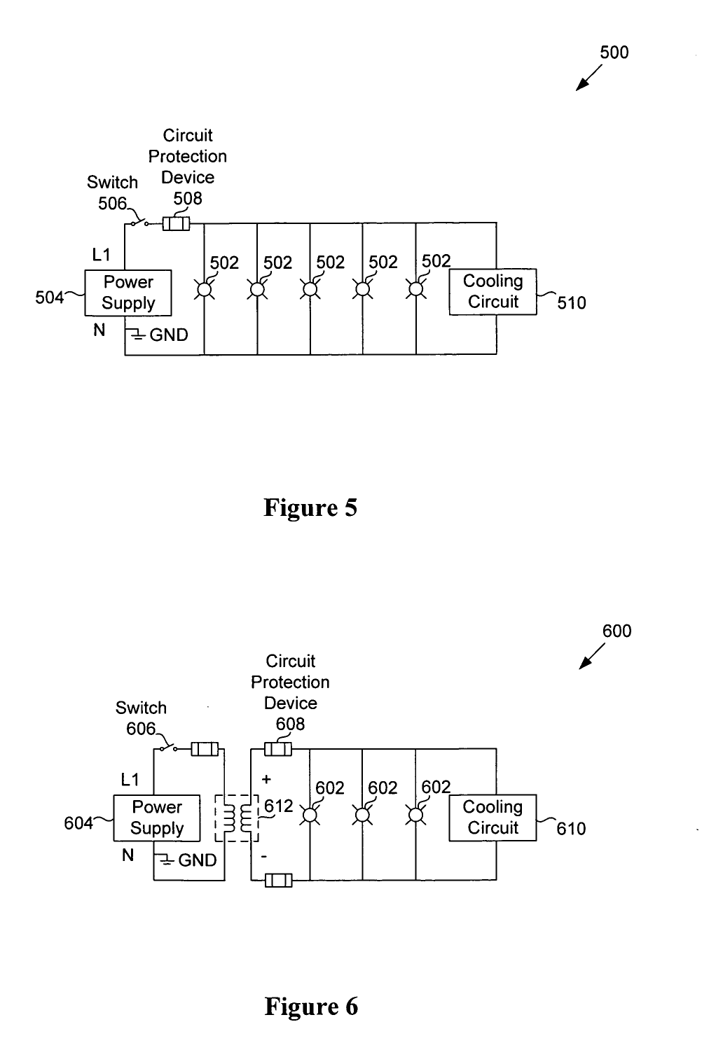

FIG. 5 is a schematic diagram 500 of a lighting device according to various embodiments of the present invention. Schematic diagram 500 shows a power supply 504 coupled to multiple lighting elements 502 (e.g., LEDs) connected in parallel with a cooling circuit 510.

Cooling circuit 510 can include a fan (e.g., 224) and temperature sensors for controlling the fan. Lighting elements 502 and cooling circuit 510 can be protected by a circuit protection device 508. Furthermore, a switch 506 may be used to control the flow of electricity to them.

FIG. 6 is a schematic diagram of a lighting device according to various embodiments of the present invention. Schematic diagram 600 shows a power supply 604 coupled to an electrical power converter 612, which is further coupled to multiple lighting elements 602 (e.g., LEDs) connected in parallel with a cooling circuit 610. Cooling circuit 610 can include a fan (e.g., 224) and temperature sensors for controlling the fan. Lighting elements 602, cooling circuit 610, and electrical power converter 612 can be protected by various circuit protection devices 608. Furthermore, a switch 606 may be used to control the flow of electricity to them.

FIGS. 7A and 7B are respectively top perspective view 700 and bottom perspective view 720 of a lighting element mount system having a mount 708 for use with a lighting element 702 according to various embodiments of the present invention. Mount 708 is configured to include pin holes 710 for electrically connecting to pins 704 of lighting element 702. Pins 704 are further electrically connected to lighting element 702 whereas pin holes 710 are further electrically connected to connection points 712. The connections between pins 704, pin holes 710, and connection points 712 can be organized based on a common polarity (e.g., “+”, “−”) or voltage potential (e.g., L1, N). Pin holes 710 and connection points 712 can penetrate mount 708 from an upper surface 716 to an opposite surface 718 such that electrical connections can be made on either surfaces. Generally, mount 708 can be made of any suitable material for providing adequate heat dissipation from the lighting element 702 while not short circuiting the pin holes 710, connection points 712, or pins 704.

Mount 708 also includes grooves/channels 714 configured to allow interconnects to route to the pin holes 710 and/or connection points 712. The bottom surface 719 is configured to attach the mount to any suitable surface, such as a frame of a lighting device (e.g., 100 or 200). Any suitable mechanism or technique may be used for the attachment, such as solder, epoxy, or double sided heat sink adhesive tape. In this way, mount 708 can be pre-wired to the frame of a lighting device such that lighting elements 702 can be easily added or removed. It should be noted that the mechanism or technique used to attach the mount to the frame should also provide adequate heat dissipation from lighting element 702.

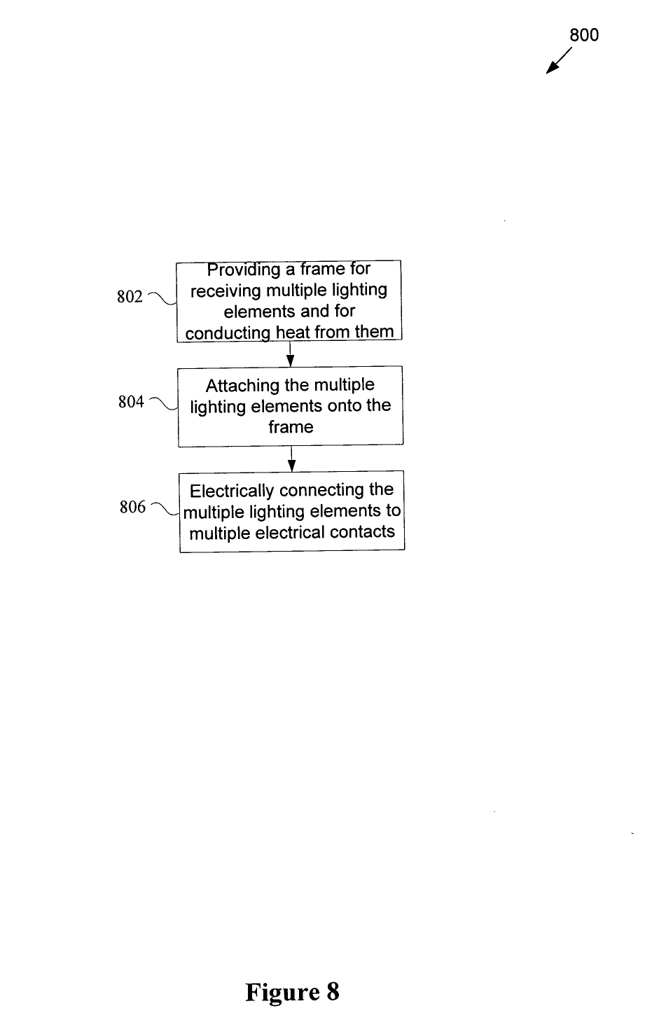

FIG. 8 is a flow chart 800 for forming a lighting device according to various embodiments of the present invention. Flow chart 800 begins at operation 802 by providing a frame for receiving multiple lighting elements (e.g., LEDs) and for conducting heat from them. Next, attaching the multiple lighting elements onto the frame can be performed in operation 804. Next, electrically connecting the multiple lighting elements to multiple electrical contacts is performed in operation 806.

Flow chart 800 can be modified in any suitable manner. Operations 802, 804, and 806 can either be repeated or modified to suit the application. For example, flow chart can include the following operations:

1) Drill holes in pipe (e.g., 104, 204) approximately ¾″ apart for mounting LEDs (e.g., 102, 202) and for vent holes (e.g., 116, 216).

2) Drill holes around chassis (e.g., 110, 210) and on the top of the cap (e.g., 130, 230) for additional venting.

3) Strip the end of one long wire (e.g., 106, 206) and solder it to a positive (+) marked connector (e.g., 122, 222) of one of the LEDs.

4) Strip both leads of the low voltage connector wires (e.g., 206a, 206b) and note the positive (+) lead as it will be connected to the power supply (e.g., 226) later.

5) Determine locations of LEDs along the pipe and feed the opposite end of the positive lead connected to the LED into the appropriate hole and through to the bottom of the pipe.

6) Slip a piece of heat shrink tube (e.g., 107, 207) over the positive lead of the low voltage wire connector. Twist together and solder the LED positive lead wire to the low voltage positive connector lead.

7) Slide the heat shrink tube on the positive low voltage wire connector over the soldered wire leads. Use a hot air blower to heat and shrink the tubing to complete insulation of the soldered connection.

8) Strip and solder a wire lead to a negative (−) connection point on the LED and feed the opposite end of the lead through an adjacent hole in the pipe.

9) Attach a small piece of double-sided heat sink tape (e.g., 118, 218) to the back of the LED star mount and carefully feed the positive and negative leads into the pipe. Secure the LED to the pipe with the tape and by pulling the two leads snugly.

10) Pass the opposite end of the negative lead through to the outside of the pipe through a hole adjacent to the location of the next LED to be mounted.

11) Solder a wire lead to a negative post of the next LED. Feed the lead into the pipe through the next adjacent hole. Attach double-sided heat sink tape to the back of the LED star and mount it to the pipe so the positive connection point is ready to be soldered to the negative lead of the first LED.

12) Cut, strip and solder the negative lead of the first LED to the second LED positive (+) connection so mounting is snug.

13) Repeat the procedure and wire one LED negative (−) connection to the next LED positive (+) connection in series by weaving the wires in and out of the pipe and fastening the LEDs to the pipe with tape and snugly soldered connections.

14) Solder a long wire lead to the last LED negative connection so it can be passed through the pipe and be oldered to the negative lead of the low voltage connector and shrink tube insulated as performed earlier for the positive lead.

15) Pass the low voltage wire connector assembly through the washer (e.g., 112, 212) and slide the washer over the pipe.

16) Repeat operation 15 with another washer (e.g., 114, 214) and set aside the pipe and LED assembly.

17) Connect the negative lead (N1—e.g., 208b) of the chassis to the “neutral” push connection of the power supply.

18) Connect the positive lead (L1—e.g., 208a) of the chassis to the positive “line” connection of the power supply.

19) Attach the low voltage connector to the power supply. Carefully slide the power supply through the pipe being careful of the wiring until the pipe assembly rests at the bottom of the inside of the chassis.

20) Before final assembly, test the pipe light to insure all LEDs are functional.

21) Hold LED pipe assembly firmly butted against the bottom of the chassis and slide washer (e.g., 114, 214) along the outside of the pipe into the chassis. Adjust the pipe and chassis so washer and pipe sit flush and straight along the top edge of the chassis and around the pipe.

22) Repeat operation 21 with washer (e.g., 112, 212) but slide the washer over the top of the chassis to rest along the top edge.

23) Slide cap on the end of the pipe and replace any lamp bulb with the same socket as used for chassis with the pipe light.

### EXAMPLES

The following examples provide details concerning lighting devices in accordance with specific embodiments of the present invention. It should be understood the following is representative only, and that the invention is not limited by the detail set forth in these examples.

Temperature tests were performed on three pipe light embodiments constructed from conventional sink drainpipes, Advance Transformer Company power supplies available from Future Electronics of Montreal, Quebec, Canada, and standard screw in light 120 AC volt socket adapters. Each pipe light was turned on for substantially twenty-four continuous hours. Various temperatures were measured using thermal sensors placed in strategic locations on each light. For example, one sensor was along the pipe exterior (e.g., outer surface 126), typically between 2 LEDs, approximately ¾″ apart from the center of each LED dome lens (e.g., 120). A second sensor was placed inside the pipe, but did not touch the interior sides (e.g., inner surface 128) of the pipe unless noted otherwise. A pipe (i.e., P2) which had the LEDs placed to direct light in one direction had an additional sensor placed on the exterior backside of the pipe, farthest away from the LEDs. To record extreme temperatures, one lamp (i.e., P2) had a sensor placed at times under the LED against its base and the pipe. Ambient room temperature was recorded during the entire test.

No cooling fans were used to vent any heat from the pipe lights. All light pipes were constructed with 1.5″ sink drain tailpipe remnants having 16 to 18-gauge brass interior and chrome plated exterior. The LEDs were wired with 16-gauge wire, which was weaved into the pipe through vent holes that were drilled around the pipe. The wire was heat rated at 105 degrees Celsius. The weaving of the LED wiring into the pipe helped mount the LED against the pipe. In some cases double-sided tape had been added to the back of the LED to create a more direct coupling to the pipe for better heat sink transfer. Since the 1.5″ pipe created a tight circumference, the dime-sized LED mount touched the pipe directly under the LED dome. This created a fin-like structure where the “dime” extended off the surface/edge of the pipe. The fin effect, as well as the additional venting holes around the pipe top cap and base chassis added to the lowered thermal resistance. Since Luxeon III LEDs burned out in an earlier prototype at only 700 mA described below, and the life expectancy of 1,000 hours for the Luxeon V was limiting, the Luxeon Vs were not tested.

According to a first embodiment, Pipe Light 1 (P1) was about 5.5″ long from the pipe end to the base point of the light socket screw-in adapter. Eight Luxeon III 3-Watt LEDs (model/part #LXHL-LW3C), available from Lumileds Lighting, LLC of San Jose, Calif. or from Future Electronics of Montreal, Quebec, Canada, were spaced evenly around the pipe, approximately 1″ apart. P1 was intended to mimic the light effects of a standard incandescent light bulb. A standard table lamp was used, plugged into a power supply, which converted 120 AC to the DC low voltage requirement of the LEDs.

The power supply was an Advance Xitanium driver (model/part #LED120A0024V10F), available from Future Electronics of Montreal, Quebec, Canada, that provided 1050 mA constant current. The LEDs were arranged in a 2×4 configuration, where series of 2 LEDs in parallel were drawing 525 mA each (instead of 700 mA or 1050 mA). To further reduce possible overheating, the power supply was external to the pipe, which created a voltage drop between the external power supply DC connection and the first LED in the sequence. An estimate of approximately 475-500 mA of current was supplying the eight LED IIIs of P1. The LEDs on P1 were secured to the pipe using double-sided heat sink tape.

It should be noted that, according to Luxeon specifications, the Luxeon III LEDs could be driven at 700 mA or 1050 mA. However, in an earlier prototype, six Luxeon III LEDs connected in series were driven at 700 mA. The LEDS grew so hot that the wire insulation and soldered connections emitted an odor resembling melting insulation and the solder flux burned a darker brown. In order to stress test the device driven at 700 mA, the Luxeon III LEDs were not securely mounted to the pipe. Some LEDs were allowed to barely touch the mounting pipe so that heat transfer and dissipation would be inadequate.

The stress test proved worthwhile as after only a few hours of using the lamp, on the second day, one LED started to dim during operation. On the third day it failed altogether while all other LEDs were still functioning. However, by the end of the third day, a second LED started to dim. On the fourth day the first failed LED looked permanently damaged and never worked again. The second failing LED continued to dim, but when pressed firmly against the pipe grew momentarily brighter. This was consistent with the first LED's failure. The test was stopped after the pattern of LED failures continued.

Another earlier prototype involved using a paper cardboard frame, such as a toilet paper roll, for supporting the LEDs of the lighting device. Silicone was also used to attach the LEDs and to provide strength within the paper cardboard frame. However, the paper cardboard frame had poor heat conducting properties. As such, a pipe light mount configuration that facilitates heat dissipation (e.g., such as in a heat sink) from the LEDs in accordance to various embodiments of the present invention could significantly improve the performance (e.g., maximizing the life spans) of the LEDs.

According to a second embodiment, Pipe Light 2 (P2) was approximately 7.5″ long from the pipe end to the base point of the light socket screw-in adapter. Eight Luxeon I 1-Watt LEDs (model/part #LXHL-MWGC), available from Lumileds Lighting, LLC of San Jose, Calif. or from Future Electronics of Montreal, Quebec, Canada, were configured in series using an Advance 10 watt 350 mA Xitanium LED driver (model/part #LED120A0350C28FO), available from Future Electronics of Montreal, Quebec, Canada. In this configuration, 350 mA were delivered to each LED. A series configuration for 1 to 8 LEDs is recommended for this driver with 1 watt LEDs.

P2 was configured to have eight LEDs, 4 rows×2 columns, so that the light emitted from the lamp was directed in an approximate 45-degree angle. P2 can be used to replace an incandescent light bulb where the lamp stand is placed in the corner of a room, or in a plumber's droplight lamp holder. In both these situations light should be directed outward into the room and not back into the corner or into the plumber's face. In this specific embodiment, the power supply was concealed inside the pipe. This “bulb” can be inserted into any suitable standard screw in light socket provided that space is available. On P2, the LEDs were attached firmly to the pipe, but no double-sided tape or any other additional heat sink transferring agents were used.

According to a third embodiment, Pipe Light 3 (P3) was approximately 7.25″ long from pipe end to the base of the light socket adapter. It had six Luxeon III 3-Watt LEDs (model/part #LXHL-LW3C) mounted approximately 1″ apart between dome centers. The LEDs were attached firmly to the pipe and double-sided heat sink tape was used. P3 was intended for corner or droplight use and spreads light in approximately a 45-degree angle.

In this configuration, an Advance 17 watt 700 mA Xitanium LED driver (model/part #LED120A0700C24FO), available from Future Electronics of Montreal, Quebec, Canada, was used and mounted inside the pipe, thereby allowing P3 to be a direct replacement of a standard incandescent bulb. The LEDs were arranged electrically in series, 2 in parallel, in a 2×3 manner. In this configuration, 3-Watt LEDs were driven at 350 mA. However, it should be noted that 1-Watt LEDs can be substituted in this configuration and also driven at 350 mA, in which more LEDs can be added, 2 at a time, for a total of twelve 1-Watt LEDs.

Table 1 indicates the sensor locations for each pipe light and the measuring devices used.

TABLE 1

| | | | Sensor |
|---|---|---|---|
| Data Logger* | Thermistor** | Pipe Light | Location |
| PL004 | TH031 | N/A | ambient temp. |
| | TH036 | P2 | pipe surface, |
| | | | lit side |
| | TH037 | P2 | pipe interior |
| | TH039 | P2 | pipe surface, |
| | | | backside |
| PL010 | TH040 | P3 | pipe interior |
| | TH042 | P3 | pipe surface, |
| | | | lit side |
| | TH046 | P1 | pipe surface |
| | TH048 | P1 | Pipe interior |

*PACE Scientific XR440 “Pocket Logger”
**PACE Scientific “Type C” Thermistors

The temperature tests involved running the pipe lights for a 24-hour period. The pipe lights were turned on at 11:23. The sampling rate was set to 1 minute. However, at 12:48, TH036 was moved so tip of probe was wedged between pipe surface and underside of LED base. At 13:17, lamp power supplies were briefly shut off to reroute power cords. At this time, P3 pipe interior sensor TH040 fell into the pipe and started touching the interior pipe surface (e.g., inner surface 128).

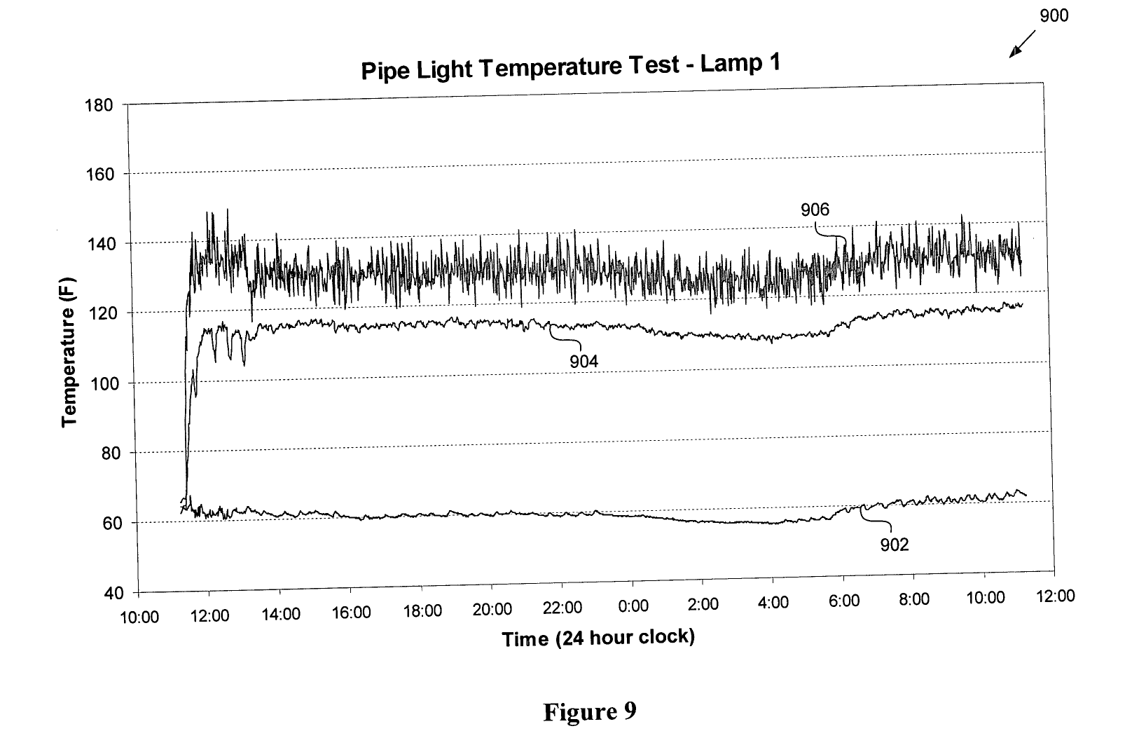

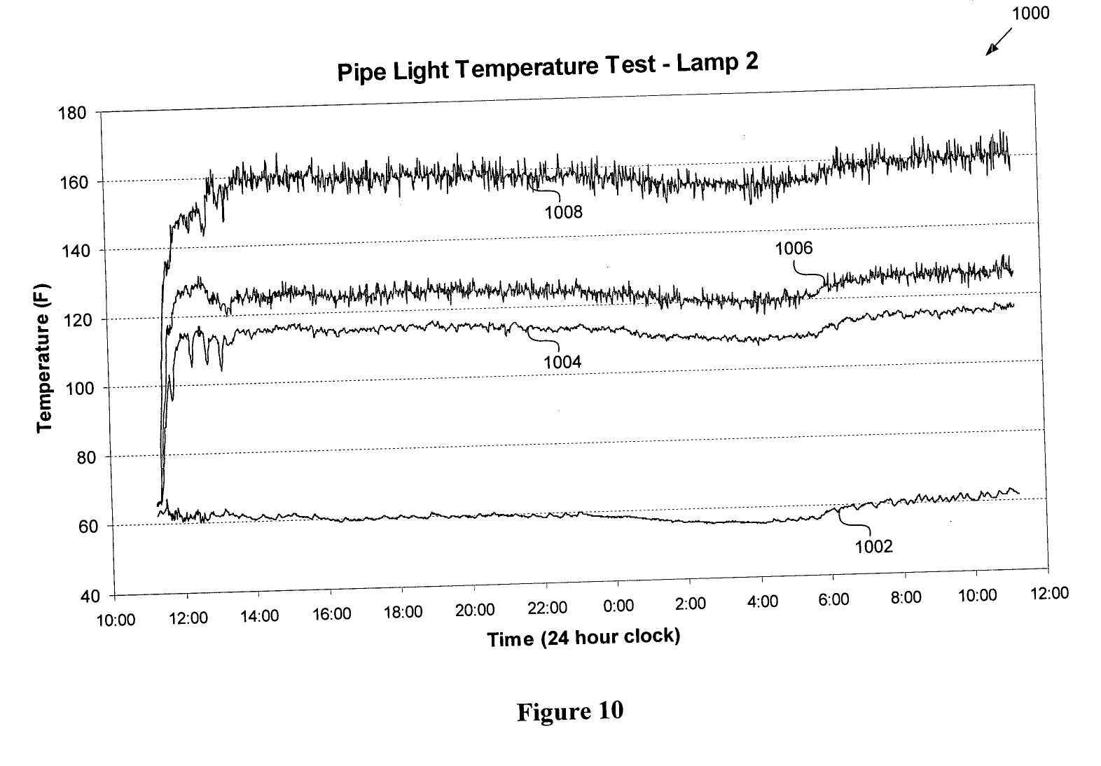

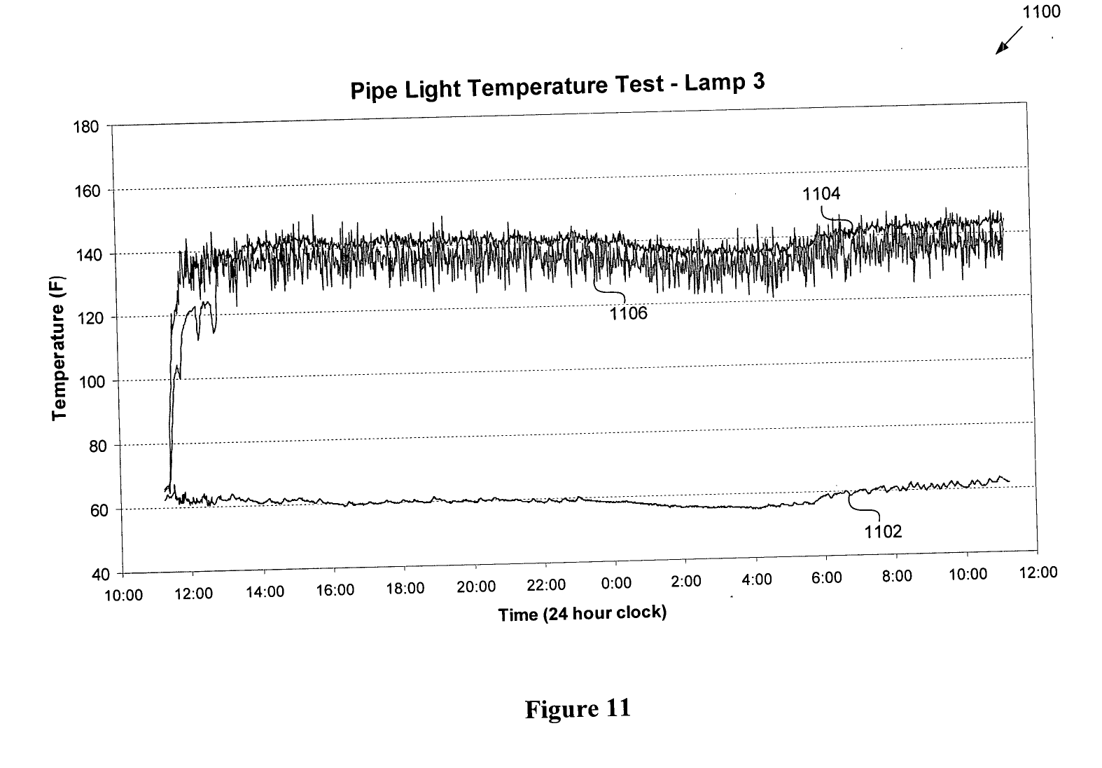

A complete recording of the measured temperatures from the sensors indicated in Table 1 is shown in FIGS. 9, 10, and 11. FIG. 9 illustrates a graph 900 plotting temperature versus time for the first embodiment. Measurement 902 (measured by TH031) is the ambient room temperature whereas measurement 904 (measured by TH048) is the pipe interior temperature and measurement 906 (measured by TH046) is the pipe surface temperature (e.g., outer surface 126). FIG. 10 illustrates a graph 1000 plotting temperature versus time for the second embodiment. Measurement 1002 (measured by TH031) is the ambient room temperature whereas measurement 1004 (measured by TH037) is the pipe interior temperature, measurement 1006 (measured by TH039) is the pipe surface (back side—e.g., outer surface 126 away from the LEDs) temperature, and measurement 1008 (measured by TH036) is the pipe surface temperature (light side—e.g., outer surface 126 near the LEDs). FIG. 11 illustrates a graph 1100 plotting temperature versus time for the third embodiment. Measurement 1102 (measured by TH031) is the ambient room temperature whereas measurement 1104 (measured by TH040) is the pipe interior temperature, and measurement 1106 (measured by TH042) is the pipe surface temperature (light side).

In general, as shown in FIGS. 9, 10, and 11, the tests for all three embodiments resulted in pipe light temperatures that remained consistent throughout the 24-hour test after the initial warm up. The pipe light temperatures lowered slightly in the early morning hours as the ambient temperature lowered. The highest pipe light temperature recorded was taken from P2, Thermistor TH036, after it had been moved directly under an LED between the pipe and the LED base (e.g., the star shaped mounting plate). The temperature at Thermistor TH036 remained at or near 160 degrees Fahrenheit throughout the remainder of the 24-hour test.

Additionally, spot readings were conducted with a Hart Sci. 1521. Table 2 shows temperature samples measured from LEDs on each pipe light. The samples were measured sequentially in the order shown in Table 2. The samples were taken with the tip of the sensor placed on top of the LED dome. Dome temperature tests for each LED were not recorded, but sampling indicated consistent temperatures.

TABLE 2

| Time | Pipe Light | Temp (° F.) |
|---|---|---|
| 12:55 | P1 | 106 |
| 12:59 | P2 | 86.5 |
| 13:00 | P3 | 84 |
| 20:54 | P1 | 86.5 |
| 20:59 | P2 | 87.6 |
| 21:04 | P3 | 86.2 |
| 12:41 | P1 | 91 |
| 12:43 | P2 | 87 |
| 12:46 | P3 | 83.3 |

An advantage of the present invention is that commonly available reclaimed materials may be used for many of the lighting device components. For example, in some embodiments of the invention, the frame for the lighting devices can be made from conventional/reclaimed piping material. For another example, in some embodiments, the chassis can be made from portions of a conventional incandescent light bulb.

While the invention has been particularly shown and described with reference to specific embodiments thereof, it will be understood by those skilled in the art that changes in the form and details of the disclosed embodiments may be made without departing from the spirit or scope of the invention. For example, ventilation holes may be integrated into any suitable portion of the lighting device, including the cap. Therefore, the scope of the invention should be determined with reference to the appended claims.

What is claimed is:

1. A lighting device, comprising:
a plurality of light emitting diodes (LEDs);
a metal frame configured to receive the plurality of LEDs, and further configured to conduct heat from the plurality of LEDs; and
electrical circuitry for providing electricity to the plurality of LEDs.

2. The lighting device of claim 1, wherein the metal frame comprises a pipe with two opposite end openings.

3. The lighting device of claim 1, further comprising an electrical power converter configured to be disposed within the metal frame.

4. The lighting device of claim 1, wherein the metal frame is configured to conduct heat from the plurality of LEDs such that a maximum temperature of an outer surface of the metal frame does not exceed 150° F.

5. The lighting device of claim 2, wherein the pipe has at least one flat outer surface.

6. The lighting device of claim 2, further comprising:
a cap configured to cover one of the end openings, the cap having an integrated fan for drawing air from inside the pipe to outside the pipe.

7. The lighting device of claim 1, further comprising:
thermal interface material for attaching the LEDS to the metal frame, the thermal interface material allowing heat from the plurality of LEDs to transfer to the metal frame.

8. The lighting device of claim 7, wherein the thermal interface material is selected from the group consisting of solder, epoxy, double sided heat sink adhesive tape.

9. The lighting device of claim 1, further comprising:
a chassis configured to receive the metal frame, the chassis having a plurality of electrical contacts for connecting a power supply to the electrical circuitry.

10. The lighting device of claim 9, wherein the electrical contacts are screw type contacts.

11. The lighting device of claim 9, further comprising:
an inner washer configured to hold in place a portion of the metal frame within the chassis.

12. The lighting device of claim 1, wherein the metal frame comprises multiple ventilation holes from an outer surface to an inner surface, the outer surface being used for receiving the plurality of LEDs.

13. The lighting device of claim 1, further comprising:
a plurality of mounts for coupling the plurality of LEDs to the metal frame.

14. The lighting device of claim 13, wherein each mount includes an upper surface for receiving one of the plurality of LEDs and a bottom surface for attaching to the metal frame, the bottom surface having a groove for routing a portion of the electrical circuitry.

15. The lighting device of claim 1, wherein the electrical circuitry connects at least a portion of the plurality of LEDs in parallel.

16. The lighting device of claim 1, wherein the metal frame is further configured to receive the plurality of LEDs such that at least two of the plurality of LEDs are facing in different directions away from the metal frame.

17. The lighting device of claim 1, further comprising:
a cover configured to be positioned around the plurality of LEDs such that light from the LEDs can be diffused.

18. The lighting device of claim 17, wherein the cover includes a slot to allow heat from the LEDs to escape through.

19. A lighting device system, comprising:
a lighting device comprising:
a plurality of light emitting diodes (LEDs);
a frame configured to receive the plurality of LEDs, and further configured to conduct heat from the plurality of LEDS such that an outer surface of the frame does not exceed 150° F.; and
electrical circuitry for providing electricity to the plurality of LEDs;
a socket configured to receive the lighting device; and
a power supply configured to supply electricity to the electrical circuitry via the socket.

20. A method of fabricating a lighting device, the method comprising:
providing a metal pipe for receiving a plurality of light emitting diodes (LEDs), and for conducting heat from the plurality of LEDs;
attaching the plurality of LEDs onto the metal pipe; and
electrically connecting the plurality of LEDs to a plurality of electrical contacts.
